(19) United States
(12) Patent Application Publication
(10) Pub. No.: US 2018/0364171 A1
(43) Pub. Date: Dec. 20, 2018

(54) DETECTION DEVICE FOR LIPIDS INCLUDED IN MICROALGAE AND DETECTION METHOD FOR LIPIDS INCLUDED IN MICROALGAE

(71) Applicant: Azbil Corporation, Chiyoda-ku (JP)

(72) Inventor: Kanami IRIE, Chiyoda-ku (JP)

(73) Assignee: Azbil Corporation, Chiyoda-ku (JP)

(21) Appl. No.: 16/060,254

(22) PCT Filed: Oct. 20, 2016
(86) PCT No.: PCT/JP2016/081109

§ 371 Date: Jun. 7, 2018

(30) Foreign Application Priority Data
Dec. 10, 2015 (JP) 2015-241441

(51) Int. Cl. G01N 21/64; G01N 21/49

(52) U.S. Cl. CPC G01N 21/6486; G01N 2021/6482; G01N 21/49; G01N 21/645

(57) ABSTRACT

A detection device for lipids included in microalgae includes a flow cell 40 through, which a fluid containing microalgae flows; an excitation, light source 10 irradiating excitation light on the flow cell 40; and a first fluorescent light detector 102A detecting autofluorescence occurring in lipids included in microalgae irradiated with the excitation light. The lipids included in the microalgae are also called oil bodies. The detection device for lipids included in microalgae may further include a scattered light detector 105 detecting scattered light generated in the microalgae irradiated with the excitation light; and a comparison unit 301 comparing the intensify of the scattered light and the intensity of the autofluorescence occurring in the lipids.

### TECHNICAL FIELD

The present invention relates to an analysis technique and relates to a detection device for lipids included in microalgae and a detection method for lipids included in microalgae.

### BACKGROUND ART

The use of lipids accumulated in microalgae as biofuels has drawn attention (for example, see Patent Literature 1 and Non Patent Literature 1). For manufacturing of biofuels from microalgae, the microalgae are cultivated, and when the amount of lipids accumulated therein becomes sufficient, the lipids are extracted from the microalgae using a solvent or the like. Among algae, although it has been reported that autofluorescence occurs in chlorophyll, phycoerythrin, and phycocyanin (for example, see Non Patent Literature 2), autofluorescence occurring in lipids has not been reported. Hence, as a method for evaluating the amount of lipids in microalgae, there has been proposed a method in which after lipids of microalgae are dyed with a fluorescent dye, the microalgae are observed using a fluorescent microscope. In addition, a method in which the content of lipids of microalgae is determined in accordance with the degree of color of a suspension liquid containing many microalgae has also been proposed (for example, see Non Patent Literature 3).

### CITATION LIST

### Patent Literature

Patent Literature 1: Japanese Unexamined Patent Application Publication No. 2014-174034

### Non Patent Literature

Non Patent Literature 1: WANG, et al., “Characterization of a green microalga UTEX 2219-4: Effects of photosynthesis and osmotic stress on oil body formation,” Botanical Studies (2011) 53: 305-312

Non Patent Literature 2: Saito et al., “Development of in situ particle diameter analysis and measurement method for blue-green algae by simultaneous detection of fluorescence components at two wavelengths”. The Review of Laser Engineering, Vol. 24, No. 4, pp. 59-66

Non Patent Literature 3: Su et al., “Simultaneous Estimation of Chlorophyll a and Lipid Contents in Microalgae by Three-Color Analysis,” Biotechnology and Bioengineering, Vol. 99, No. 4, Mar. 1, 2008

### SUMMARY OF INVENTION

### Technical Problem

To dye lipids in each microalga with a fluorescent dye will take a long time, in addition, the fluorescent dye is required to be carefully handled from a safety point of view and is also expensive. In addition, in the method in which the content of lipids is determined in accordance with the degree of color of a suspension liquid containing microalgae, the content of lipids in each microalga cannot be accurately determined. Hence, one object of the present invention is to provide a detection device for lipids included in microalgae and a detection method for lipids included in microalgae, each of which can easily and accurately detect the lipids included in the microalgae.

### Solution to Problem

Through intensive research, the present inventor discovered that when excitation light is irradiated an microalgae, autofluorescence occurs in lipids included in the microalgae.

According to one aspect of the present invention, there is provided a detection device for lipids included in microalgae, the device comprising; (a) a flow cell through which a fluid containing microalgae flows; (b) an excitation light source irradiating excitation light on the flow cell; and (c) a first fluorescent light detector detecting autofluorescence occurring in lipids of microalgae irradiated with the excitation light. The autofluorescence occurring in the lipids can be yellow.

The detection device for lipids included in microalgae described above may further comprise: a scattered light detector detecting scattered light generated in the microalgae irradiated with the excitation light; and a comparison unit comparing the intensity of the scattered light and the intensity of the autofluorescence occurring in the lipids.

The detection device for lipids included in microalgae described above may further comprise: a second fluorescent light detector detecting autofluorescence occurring in chloroplasts of the microalgae irradiated with the excitation light; and a comparison unit comparing the intensity of the autofluorescence occurring in the chloroplasts and the intensity of the autofluorescence occurring in the lipids.

The detection device for lipids included in microalgae described above may further comprise; a scattered light detector detecting scattered light generated in the microalgae irradiated with the excitation light; a second fluorescent light detector detecting autofluorescence occurring in chloroplasts of the microalgae irradiated with the excitation light; and a comparison unit comparing the intensity of the scattered light, the intensity of the autofluorescence occurring in the lipids, and the intensity of the autofluorescence occurring in the chloroplasts.

The detection device for lipids included in microalgae described above may further comprise a size calculation unit calculating the size of the lipids based on the intensity of the autofluorescence occurring in the lipids. The detection device for lipids included in microalgae described above may further comprise a size calculation unit calculating the size of the microalgae based on the intensity of the scattered light generated in the microalgae. The detection device for lipids included in microalgae described above may further comprise a size calculation unit calculating the size of the chloroplasts based on the intensity of the autofluorescence occurring in the chloroplasts.

In the detection device for lipids included in microalgae described above, the microalgae can be unicellular organisms. In addition, the microalgae may produce hydrocarbons.

In addition, according to another aspect of the present invention, there is provided a detection method for lipids included in microalgae, the method comprising: (a) allowing a fluid containing microalgae to flow through a flow cell; (b) irradiating excitation light on the flow cell; and (c) detecting autofluorescence occurring in lipids of microalgae irradiated with the excitation light. The autofluorescence occurring in the lipids can be yellow.

The detection method for lipids included in microalgae described above may further comprise: detecting scattered light generated in the microalgae irradiated with the excitation light; and comparing the intensity of the scattered light and the intensity of the autofluorescence occurring in the lipids.

The detection method for lipids included in microalgae described above may further comprise: detecting autofluorescence occurring in chloroplasts of the microalgae irradiated with the excitation light; and comparing the intensity of the autofluorescence occurring in the chloroplasts and the intensity of the autofluorescence occurring in the lipids.

The detection method for lipids included in microalgae described above may further comprise; detecting scattered light generated in the microalgae irradiated with the excitation light; detecting autofluorescence occurring in chloroplasts of the microalgae irradiated with the excitation light; and comparing the intensity of the scattered light, the intensity of the autofluorescence occurring in the lipids; and the intensity of the autofluorescence occurring in the chloroplasts.

The detection method for lipids included in microalgae described above may further comprise: calculating the size of the lipids based on the intensity of the autofluorescence occurring in the lipids. The detection method for lipids included in microalgae described above may further comprise: calculating the size of the microalgae based on the intensity of the scattered light generated in the microalgae. The detection method for lipids included in microalgae described above may further comprise: calculating the size of the chloroplasts based on the intensity of the autofluorescence occurring in the chloroplasts.

In the detection method for lipids included in microalgae described above, the microalgae can be unicellular organisms. In addition, the microalgae may produce hydrocarbons.

### Advantageous Effects of Invention

According to the present invention, a detection device for lipids included in microalgae and a detection method for lipids included in microalgae, each of which can easily and accurately detect the lipids included in the microalgae, can be provided.

### BRIEF DESCRIPTION OF DRAWINGS

FIG. 1 is a schematic view of a detection device for lipids included in microalgae according to an embodiment of the present invention.

FIG. 2 is a schematic view of a microalga including lipids and chloroplasts.

FIG. 3 is a schematic view of a microalga including lipids and chloroplasts.

FIG. 4 is a schematic view of a microalga including lipids and chloroplasts.

FIG. 5 is a microscopic image of chlorella without fluorescent dyeing according to Reference Example 1 of the present invention.

FIG. 6 is a microscopic image of autofIuorescence of the chlorella without fluorescent dyeing according to Reference Example 1 of the present invention.

FIG. 7 includes the microscopic image of the autofIuorescence of the chlorella without fluorescent dyeing according to Reference Example 1 of the present invention and an extraction image of the autofIuorescence.

FIG. 8 is an image obtained by overlapping the extraction image of the autofluorescence on the microscopic image of the chlorella without fluorescent dyeing according to Reference Example 1 of the present invention.

FIG. 9 is a microscopic image of fluorescent dyed chlorella according to Reference Example 2 of the present invention.

FIG. 10 is a microscopic image of the fluorescence of the fluorescent-dyed chlorella according to Reference Example 2 of the present invention.

FIG. 11 includes the microscopic image of the fluorescence of the fluorescent-dyed chlorella according to Reference Example 2 of the present invention and an extraction image of autofIuorescence.

FIG. 12 is an image obtained by overlapping an extraction image of the fluorescence on the microscopic image of the fluorescent-dyed chlorella according to Reference Example 2 of the present invention.

FIG. 13 is a microscopic image of chlorella without fluorescent dyeing according to Reference Example 3 of the present invention.

FIG. 14 is a microscopic image of autofluorescence of the chlorella without fluorescent dyeing according to Reference Example 3 of the present invention.

FIG. 15 includes the microscopic image of the autofluorescence of the chlorella without fluorescent dyeing according to Reference Example 3 of the present invention and an extraction image of the autofluorescence.

FIG. 16 is an image obtained by overlapping the extraction image of the autofluorescence on the microscopic image of the chlorella without fluorescent dyeing according to Reference Example 3 of the present invention.

FIG. 17 is a microscopic image of fluorescent-dyed chlorella according to Reference Example 4 of the present invention.

FIG. 18 is a microscopic image of the fluorescence of the fluorescent-dyed chlorella according to Reference Example 4 of the present invention.

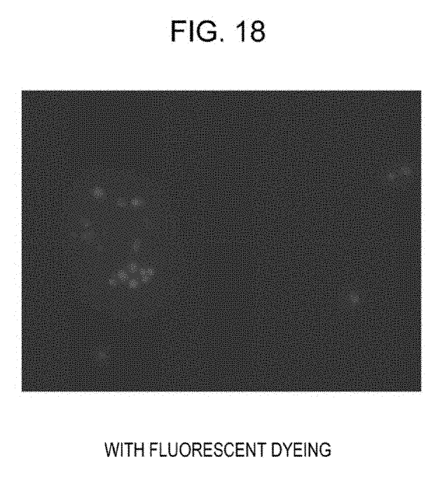

FIG. 19 includes the microscopic image of the fluorescence of the fluorescent-dyed chlorella according to Reference Example 4 of the present invention and an extraction image of the fluorescence.

FIG. 20 is an image obtained by overlapping the extraction image of the fluorescence on the microscopic image of the fluorescent-dyed chlorella according to Reference Example 4 of the present invention.

### DESCRIPTION OF EMBODIMENTS

Hereinafter, embodiments of the present invention will be described. However, it is not to be understood that the present invention is limited to description and drawings which partially form the present disclosure. From the present disclosure, various alternative techniques and application techniques are to be apparent to a person skilled in the art, and it is to be understood that the present invention includes various embodiments which are not described in this specification.

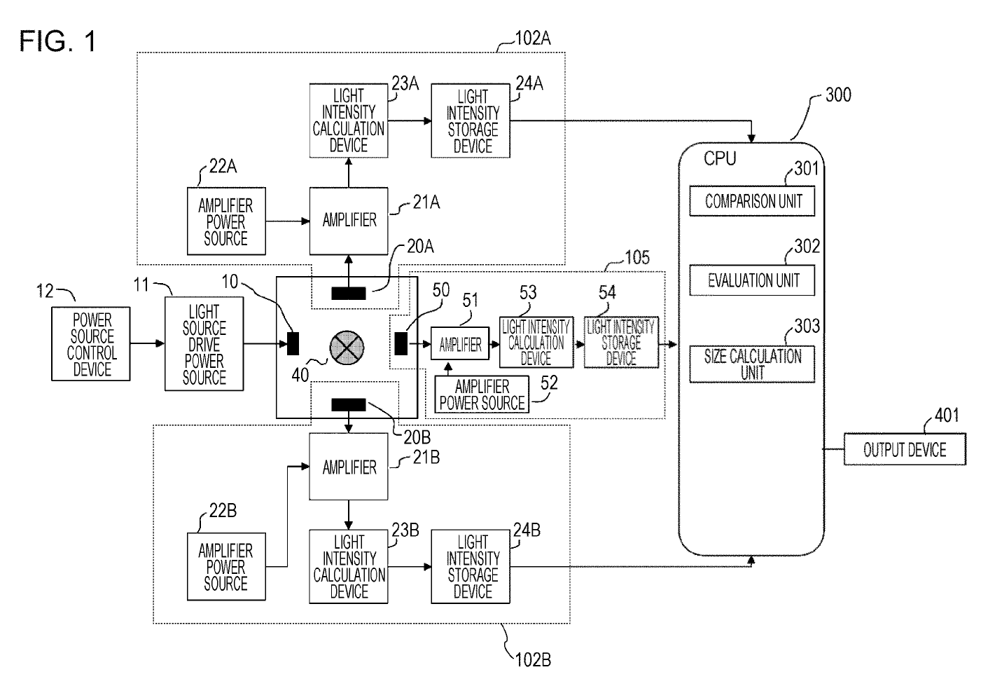

A detection device for lipids included in microalgae according to an embodiment includes, as shown in FIG. 1, a flow cell 40 through which a fluid containing microalgae flows, an excitation light source 10 irradiating excitation light on the flow cell 40, and a first fluorescent light detector 102A detecting autofluorescence occurring in lipids in microalgae irradiated with the excitation light. The lipids included in the microalgae are also called oil bodies. The fluid flowing through the flow cell 40 may be either a liquid or a gas. Hereinafter, the case in which a liquid is used as the fluid will be described by way of example.

The excitation light source 10 irradiates excitation light having a broadband wavelength onto the liquid flowing through the flow cell 40. As the excitation light source 10, for example, a light emitting diode (LED) and a laser may be used. The excitation light is, for example, blue light having a wavelength of 450 to 495 nm. However, the wavelength and the color of the excitation light are not limited thereto. Visible light rays, such as purple color, other than the blue light may be used, and ultraviolet rays may also be used. The wavelength band of the excitation light may be determined by a filter, such as a bandpass filter. The excitation light is focused, for example, in the flow cell 40. To the excitation light source 10, a light source drive power source 11 supplying an electrical power to the excitation light source 10 is connected. To the light source drive power source 11, a power source control device 12 controlling the electrical power to be supplied to the excitation light source 10 is connected.

The flow cell 40 is transparent to the excitation light and is formed, for example, of quartz. The flow cell 40 has an internal diameter so that the microalgae are approximately allowed to pass therethrough one by one. The flow cell 40 has, for example, a round tube shape or a square tube shape. The liquid flowing through the flow cell 40 intersects the excitation light.

The microalgae are algae which are unicellular organisms each having a size of, for example, several micrometers to several tens of micrometers. The microalgae are called phytoplankton in some cases. In addition, for example, the microalgae produce hydrocarbons. As examples of the microalgae, for example, there may be mentioned Botryococcus braunii, Aurantiochytrium, Pseudochoricystis ellipsoidea, Scenedesmus, Desmodesmus, Chlorella, Dunaliella Arthrospira, Spirulina, Euglena, Nannochloropsis, Haematococcus, and Microcystis aeruginosa.

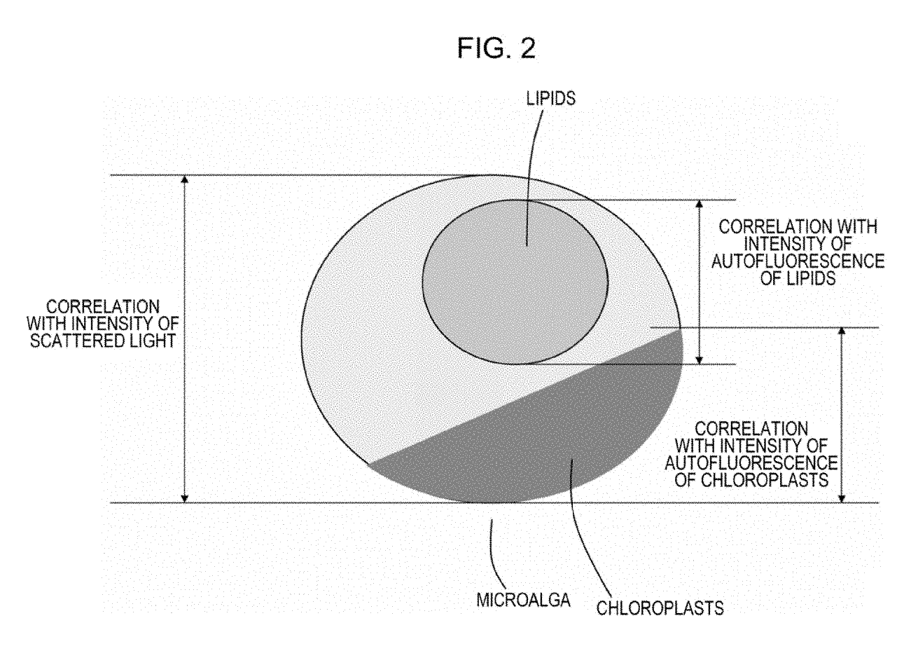

When the microalgae are contained in the liquid flowing through the flow cell 40, the lipids included in the microalgae irradiated with the excitation light basically emit yellow autofluorescence having a wavelength of 540 to 620 nm. The wavelength peak of the autofluorescence of the lipids is approximately 570 to 590 nm. As shown in FIG. 2, the intensity of the autofluorescence emitted from the lipids reflects the size of the lipids included in the microalga. In addition, chloroplasts included in the microalga irradiated with the excitation light basically emit red autofluorescence having a wavelength of 650 to 730 nm. The wavelength peak of the autofluorescence of the chloroplasts is approximately 680 to 700 nm. The intensity of the autofluorescence emitted from the chloroplasts reflects the size of the chloroplasts included in the microalga. In addition, the excitation wavelength for the autofluorescence of the lipids may be the same as that for the autofluorescence of the chloroplasts. Furthermore, in the microalga irradiated with the excitation light, scattered light is generated by Mie scattering. The intensity of the scattered light reflects the size of one entire microalga.

In this case, the “size” represents, for example, the diameter, the area, or the volume. For example, when the shapes of the microalga, the region formed of the lipids included in the microalga, and the chloroplasts each can be approximated to the shape of a particle, the “size” may represents the particle diameter.

In addition, the wavelength of the autofluorescence described above is obtained when the wavelength band of the excitation light is 460 to 495 nm and is a value obtained through an absorption filter which absorbs light having a wavelength of lees than 510 nm and which allows a light having a wavelength of 510 nm or more to pass therethrough, so that the wavelength of the autofluorescence described above may be changed depending on the conditions. However, the relationship in that the wavelength band of the autofluorescence of the lipids is shorter than the wavelength band of the chloroplasts is maintained.

As shown in FIG. 1, the first fluorescent light detector 102A detecting the autofluorescence occurring in the lipids of the microalgae includes a first light receiving element 20A receiving the autofluorescence occurring in the lipids of the microalgae. In front of the first light receiving element 20A, a filter, such as an absorption filter, which sets the wavelength band of light receivable by the first light receiving element 20A may be disposed. As the first light receiving element 20A, for example, there may be used an internal photoelectric effect (photovoltaic effect) photosensor, such as a photodiode or a solid-state imaging element including a charge-coupled device (CCD) image sensor; or an external photoelectric effect photosensor, such as a photomultiplier tube, and when the autofluorescence occurring in the lipids is received, photo energy is converted into electrical energy. To the first light receiving element 20A, an amplifier 21A amplifying a current generated in the first light receiving element 20A is connected. To the amplifier 21A, an amplifier power source 22A supplying an electrical power to the amplifier 21A is connected.

In addition, to the amplifier 21A, a light intensity calculation device 23A which receives a current amplified by the amplifier 21A and which calculates the intensity of the autofluorescence occurring in the lipids received by the first light receiving element 20A is connected. The light intensity calculation device 23A calculates the intensity of the autofluorescence occurring in the lipids, for example, based on the area of a spectrum of the autofluorescence thus detected. The light intensity calculation device 23A may calculate the intensity of the autofluorescence occurring in the lipids using an image analysis software. Alternatively, the light intensity calculation device 23A may calculate the intensity of the autofluorescence occurring in the lipids based on the magnitude of an electrical signal generated in the first light receiving element 20A. To the light intensity calculation device 23A, a light intensity storage device 24A which stores the intensity of the autofluorescence occurring in the lipids calculated by the light intensity calculation device 23A is connected.

The detection device for lipids included in microalgae according to the embodiment may further include a second fluorescent light detector 102B detecting the autofluorescence occurring in the chloroplasts of the microalgae. The second fluorescent light detector 102B includes a second light receiving element 20B receiving the autofluorescence occurring in the chloroplasts of the microalgae. In front of the second light receiving element 20B, a filter, such as an absorption filter, which sets the wavelength band of light receivable by the second light receiving element 20b may be disposed. As the second light receiving element 20B, for example, there may be used an internal photoelectric effect (photovoltaic effect) photosensor, such as a photodiode or a solid-state imaging element including a charge-coupled device (CCD) image sensor; or an external photoelectric effect photosensor, such as a photomultiplier tube, and when the autofluorescence occurring in the chloroplasts is received, photo energy is converted into electrical energy. To the second light receiving element 20B, an amplifier 21B amplifying a current generated in the second light receiving element 20B is connected. To the amplifier 21B, an amplifier power source 22B supplying an electrical power to the amplifier 21B is connected.

In addition, to the amplifier 21B, a light intensity calculation device 23B which receives a current amplified by the amplifier 21B and which calculates the intensity of the autofluorescence occurring in the chloroplasts received by the second light receiving element 20B is connected. The light intensity calculation device 23B calculates the intensity of the autofluorescence occurring in the chloroplasts, for example, based on the area of a spectrum of the autofluorescence thus detected. The light intensity calculation device 23B may calculate the intensity of the autofluorescence occurring in the chloroplasts using an image analysis software. Alternatively, the light intensity calculation device 23B may calculate the intensity of the autofluorescence occurring in the chloroplasts based on the magnitude of an electrical signal generated in the second light receiving element 20B. To the light intensity calculation device 23B, a light intensity storage device 24B which stores the intensity of the autofluorescence occurring in the chloroplasts calculated by the light intensity calculation device 23B is connected.

The detection device for lipids included in microalgae according to the embodiment may further include a scattered light detector 105 receiving scattered light generated in the microalgae irradiated with the excitation light. The scattered light detector 105 includes a scattered light receiving element 50 receiving the scattered light. As the scattered light receiving element 50, for example, there may be used an internal photoelectric effect (photovoltaic effect) photosensor, such as a photodiode or a solid-state imaging element including a charge-coupled device (CCD) image sensor; or an external photoelectric effect photosensor, such as a photomultiplier tube, and when the light is received, photo energy is converted into electrical energy. To the scattered light receiving element 50, an amplifier 51 amplifying a current generated in the scattered light receiving element 50 is connected. To the amplifier 51, an amplifier power source 52 supplying an electrical power to the amplifier 51 is connected.

In addition, to the amplifier 51, a light intensity calculation device 53 which receives a current amplified by the amplifier 51 and which calculates the intensity of the scattered light received by the scattered light receiving element 50 is connected. The light intensity calculation device 53 calculates the intensity of the scattered light, for example, based on the area of a spectrum of the scattered light thus detected. The light intensity calculation device 53 may calculate the intensity of the scattered light using an image analysis software. Alternatively, the light intensity calculation device 53 may calculate the intensity of the scattered light based on the magnitude of an electrical signal generated in the scattered light receiving element 50. To the light intensity calculation device 53, a light intensity storage device 54 which stores the intensity of the scattered light calculated by the light intensity calculation device 53 is connected.

When the liquid flows through the flow cell 40, the excitation light source 10 irradiates the excitation light, the first and the second fluorescent light detectors 102A and 102B measure the intensity of the autofluorescence occurring in the lipids of the microalgae and the intensity of the autofluorescence of the chloroplasts of the microalgae, respectively, and those intensities are stored in the light intensity storage devices 24A and 24B, respectively, in a time sequential manner. In addition, the scattered light detector 105 measures the scattered light generated in the microalgae, and the light intensity of the scattered light is stored in the light intensity storage device 54 in a time sequential manner. The autofluorescences having two wavelength bands and the scattered light measured at the same time can be regarded to be derived from the same microalga.

The detection device for lipids included in microalgae according to the embodiment further includes a central processing unit (CPU) 300. The CPU 300 includes a comparison unit 301 comparing the intensity of the scattered light, the intensity of the autofluorescence occurring in the lipids, and the intensity of the autofluorescence occurring in the chloroplasts which are detected at the same time.

The comparison unit 301 reads the intensity of the autofluorescence occurring in the lipids of the microalgae and the intensity of the autofluorescence occurring in the chloroplasts of the microalgae from the light intensity storage devices 24A and 24B, respectively. In addition, the comparison unit 301 reads the intensity of the scattered light generated in the microalgae from the light intensity storage device 54.

Furthermore, the comparison unit 301 calculates, for example, the ratio of the intensity of the autofluorescence occurring in the lipids of the microalgae to the intensity of the scattered light. After the value of the intensity of the scattered light is normalized to 100 or the like, the comparison unit 301 may calculate the ratio of the intensity of the autofluorescence occurring in the lipids of the microalgae to the normalized intensity of the scattered light.

In addition, the comparison unit 301 calculates, for example, the ratio of the intensity of the autofluorescence occurring in the chloroplasts of the microalgae to the intensity of the scattered light. The comparison unit 301 may calculate the ratio of the intensity of the autofluorescence occurring in the chloroplasts of the microalgae to a normalized intensity of the scattered light.

The CPU 300 may further include an evaluation unit 302. The evaluation unit 302 evaluates the state of the microalgae from the results obtained by the comparison among the intensity of the scattered light generated in the microalgae, the intensity of the autofluorescence occurring in the lipids, and the intensity of the autofluorescence occurring in the chloroplasts.

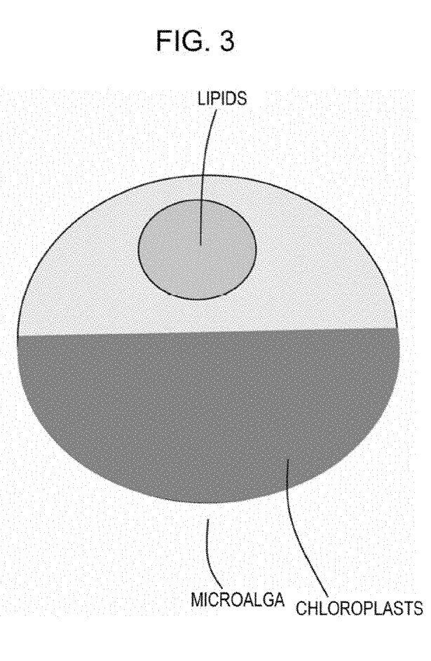

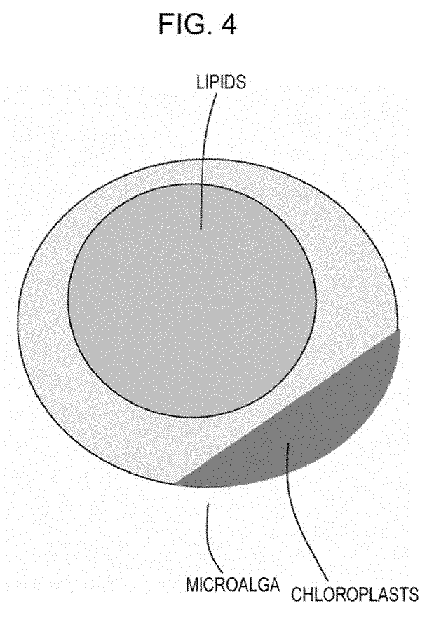

For example, when the ratio of the intensity of the autofluorescence occurring in the lipids of the microalgae to the intensity of the scattered light generated in the microalgae is smaller than a predetermined discrimination value, as shown in FIG. 3, the ratio of the lipids in the microalga is evaluated to be small. In addition, when the ratio of the intensity of the autofluorescence occurring in the lipids of the microalgae to the intensity of the scattered light generated in the microalgae is larger than the predetermined discrimination value, as shown in FIG. 4, the ratio of the lipids in the microalga is evaluated to be large.

Furthermore, for example, when the ratio of the intensity of the autofluorescence occurring in the chloroplasts of the microalgae to the intensity of the scattered light generated in the microalgae is smaller than a predetermined discrimination value, as shown in FIG. 4, the ratio of the chloroplasts in the microalga is evaluated to be small. In addition, when the ratio of the intensity of the autofluorescence occurring in the chloroplasts of the microalgae to the intensity of the scattered light generated in the microalgae is larger than the predetermined discrimination value, as shown in FIG. 3, the ratio of the chloroplasts in the microalga is evaluated to be large.

The CPU 300 shown in FIG. 1 may further include a size calculation unit 303. The size calculation unit 303 calculates the size of the microalgae based on the intensity of the scattered light generated in the microalgae. The size calculation unit 303 may calculate the size of the microalgae based on the relationship between the intensity of the scattered light and the size of the microalgae which is obtained in advance.

In addition, the size calculation unit 303 calculates the size of the lipids in the microalgae based on the intensity of the autofluorescence occurring in the lipids. The size calculation unit 303 may calculate the size of the lipids based on the relationship between the intensity of the autofluorescence of the lipids and the size of the lipids which is obtained in advance.

Furthermore, the size calculation unit 303 calculates the size of the chloroplasts in the microalgae based on the intensity of the autofluorescence occurring in the chloroplasts. The size calculation unit 303 may calculate the size of the lipids based on the relationship between the intensity of the autofluorescence of the chloroplasts and the size of the chloroplasts which is obtained in advance.

The comparison unit 301 may compare the size of tine microalgae, the size of the lipids, and the size of the chloroplasts, each of which is calculated by the size calculation unit 303.

To the CPU 300, an output device 401 is connected. The output device 401 outputs a calculation result of the CPU 300. As the output device 401, for example, a display, a speaker, or a printer may be used.

The detection device for lipids included in microalgae according to the embodiment described above is able to detect the lipids included in each microalga without performing fluorescent dyeing in advance. For example, when a large amount of microalgae is cultivated, fluorescent dyeing is not easily performed on all the microalgae. On the other hand, by the use of the detection device for lipids included in microalgae according to the embodiment, when a plurality of microalgae is continuously allowed to flow through the flow cell, the lipids included in each microalga can be rapidly and optically detected.

In addition, by the detection device for lipids included in microalgae according to the embodiment, when the intensity of the scattered light and the intensity of the autofluorescence occurring in the lipids are compared to each other, the state of each microalga can also be evaluated.

In recent years, attempts to use lipids included in microalgae as biofuels, pharmaceuticals, cosmetics, supplements, and the like have been carried out. Since the amount of lipids included in microalgae is changed, for example, by the cultivation conditions and other environmental conditions, the ratio of the size of the lipids to the size of one entire microalga is not constant. On the other hand, when the lipids in the microalgae are used, the ratio of the size of the lipids to the size of one entire microalga is preferably large.

On the other hand, by the detection device for lipids included in microalgae according to the embodiment, when the intensity of the scattered light and the intensity of the autofluorescence occurring in the lipids are compared to each other, the ratio of the size of the lipids to the size of one entire microalga can be obtained. Hence, culture conditions under which microalgae including a large amount of lipids are likely to be generated and other environmental conditions can be screened. In addition, from a plurality of microalgae, a microalga including a large amount of lipids can also be screened.

In addition, heretofore, although it has been reported that chlorophyll, phycoerythrin, and phycocyanin each emit autofluorescence, autofluorescence occurring in lipids has not been reported. The reason for this is believed that since lipids have been generally investigated by fluorescent dyeing, attention has not been paid on the autofluorescence of lipids, and the autofluorescence thereof has not been known.

### Reference Example 1

From Microbial Culture Collection of National Institute for Environmental Studies, Chlorella (Chlorella vulgaris Beijerinck, NIES-2170) was subdivided. Subsequently, the chlorella was cultivated in a liquid C medium in a constant-temperature bath at 25° C. During the cultivation, a test tube in which the chlorella and the liquid C medium were received was shook at 100 rpm. In addition, during the cultivation, in accordance with the culture conditions recommended by the institute from which the chlorella was subdivided, in the constant-temperature bath, daylight lighting by a fluorescent tube for 10 hours and no lighting for 14 hours were repeatedly performed.

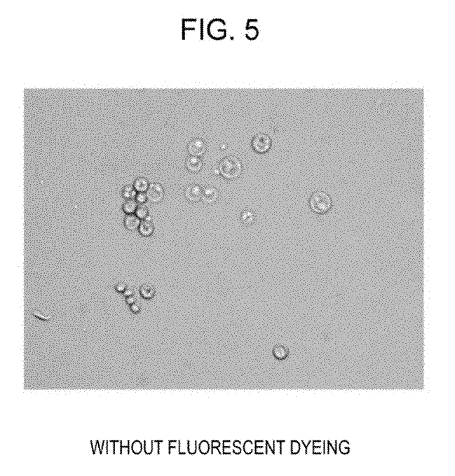

After 10 μL of the liquid C medium containing the chlorella which was cultivated without fluorescent dyeing was dripped on a slide glass, a cover glass was placed thereon. Next, by the use of a microscope equipped with an UIS manufactured by Olympus Corporation, a transmission microscopic image shown in FIG. 5 of the chlorella without fluorescent dyeing was taken.

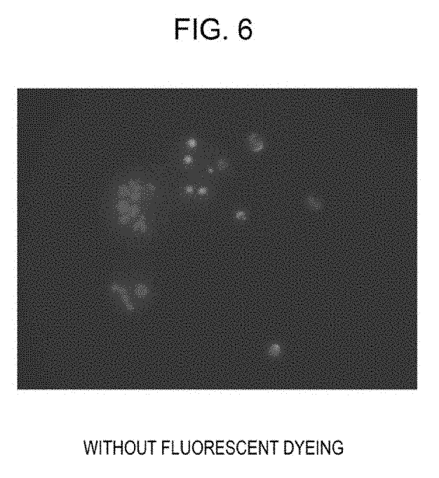

Subsequently, while the slide glass was not moved, a fluorescent microscopic image shown in FIG. 6 of the chlorella without fluorescent dyeing was taken by the same microscope. In particular, wideband (HT3) excitation light emitted from an excitation light source was made to have a wavelength band of 460 to 495 nm through a bandpass filter (BP 460-495) and was then irradiated on the chlorella without fluorescent dyeing through an object lens. The autofluorescence occurring in the chlorella without fluorescent dyeing which was irradiated with the excitation light was taken by a camera through an object lens and an absorption filter (BA510IF) which absorbed light having a wavelength of less than 510 nm and which allowed light having a wavelength of 510 nm or more to pass therethrough. An irradiation time of the excitation light (exposure time of the chlorella) was 1.0 second. In addition, for the excitation light, a neutral density (ND) filter was not used.

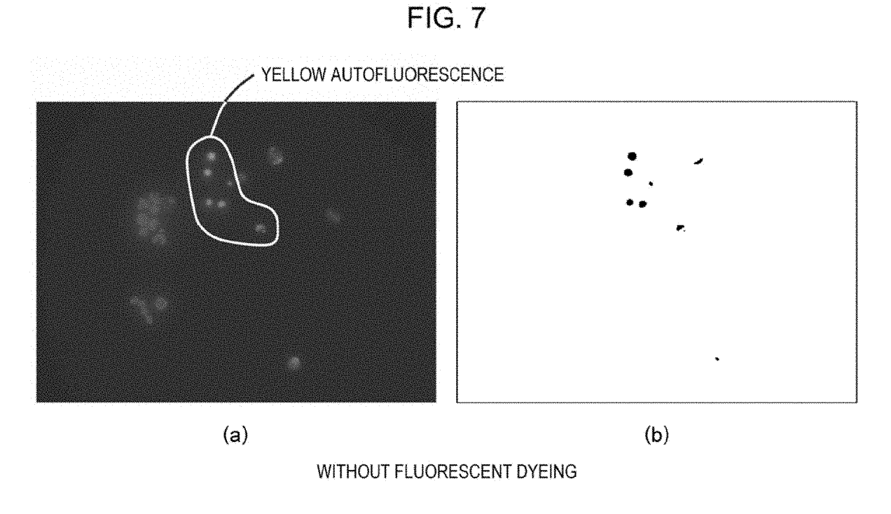

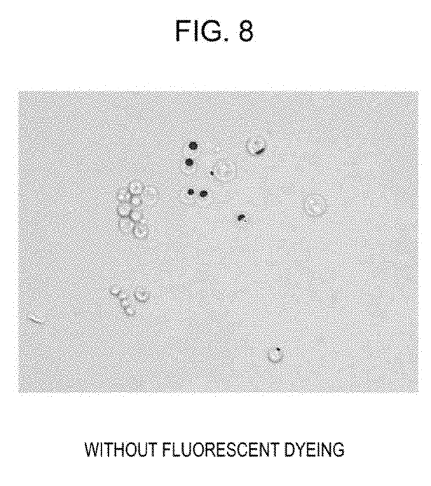

In the fluorescent microscopic image of the chlorella shown in FIG. 7(a), in a region surrounded by a line, yellow autofluorescence was mainly observed. In the other region, red autofluorescence was mainly observed. As shown in FIG. 7(b), by the use of an image analysis software (ImagePro), portions at each of which the yellow autofluorescence was emitted in the fluorescent microscopic image of the chlorella were extracted by black, and the other portion was shown by white, so that an extraction image of the yellow autofluorescence was formed, when the extraction image of the portions at each of which the yellow autofluorescence was emitted shown in FIG. 7(b) was overlapped on the transmission microscopic image shown in FIG. 5, as shown in FIG. 8, the shapes of intracellular tissues observed in the transmission microscopic image coincided with the shapes of the portions at each of which the yellow autofluorescence was emitted.

### Reference Example 2

BODIPY (registered trade name) 493/503 which was a lipid labeling fluorescent dye having a peak wavelength of 503 nm was prepared and was then diluted in ethanol, so that a fluorescent reagent solution having a concentration of 1 mg/mL was prepared. Next, to 100 μL of a liquid C medium in which the chlorella was cultivated in the same manner as that in Reference Example 1, 0.1 μL of the fluorescent reagent solution was added, so that the chlorella was dyed with BODIPY (registered trade name).

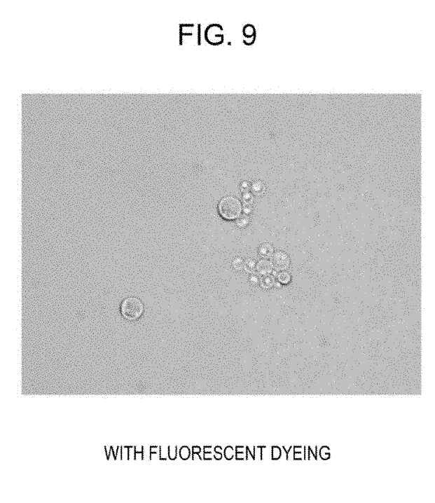

On the same day in which the microscopic observation of Reference Example 1 was performed, 10 μL of the liquid C medium containing the chlorella dyed with BODIPY (registered trade name) was dripped on a slide glass, and a cover glass was placed thereon. Next, by a microscope equipped with an VIS manufactured by Olympus Corporation, a transmission microscopic image shown in FIG. 9 of the chlorella dyed with BODIPY (registered trade name) was taken.

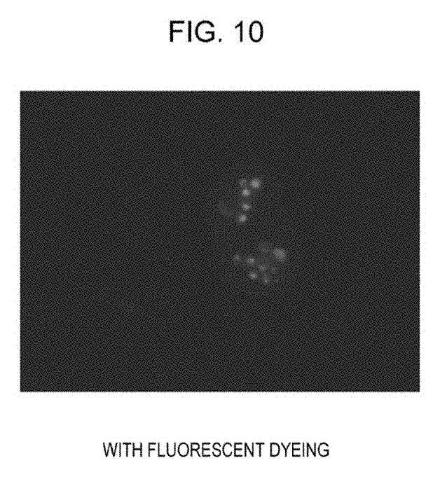

Subsequently, while the slide glass was not moved, a fluorescent microscopic image shown in FIG. 10 of the chlorella dyed with BODIPY (registered trade name) was taken by the same microscope. In particular, wideband (WIB) excitation light was emitted through a bandpass filter (BP 460-495) to have a wavelength band of 460 to 495 nm and was then irradiated on the chlorella which was dyed with BODIPY (registered trade name) through an object lens. The fluorescence generated in the chlorella which was dyed with BODIPY (registered trade name) and which was irradiated with the excitation light was taken by a camera through an object lens and an absorption filter (BA510IF) which absorbed light having a wavelength of less than 510 nm and which allowed light having a wavelength of 510 nm or more to pass therethrough. An irradiation time of the excitation light (exposure time of the chlorella) was 0.5 seconds. In addition, for the excitation light, an ND filter having an average transmission race (Tav) of 25% was used.

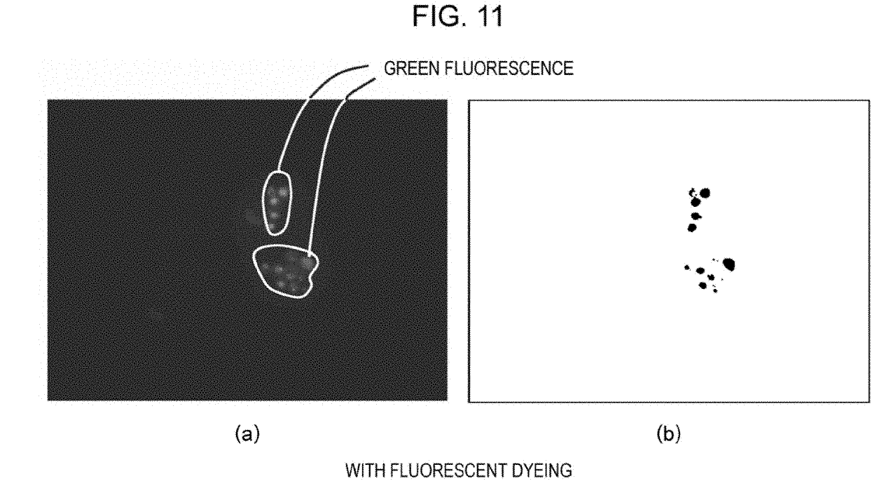

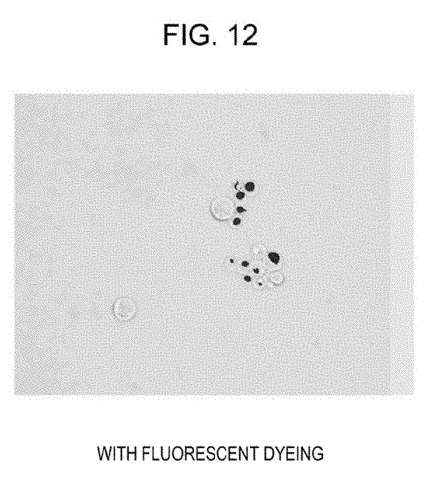

In the fluorescent microscopic image of the chlorella shown in FIG. 11(a), in a region surrounded by a line, green fluorescence was mainly observed, in the other region, red fluorescence was mainly observed. As shown in FIG. 11(b), by the use of an image analysis software (ImagePro), portions at each of which the green fluorescence was emitted in the fluorescent microscopic image of the chlorella were extracted by black, and the other portion was shown by white, so that an extraction image of the green fluorescence was formed, when the extraction image of the portions at each of which the green fluorescence was emitted shown in FIG. 11(b) was overlapped on the transmission microscopic image shown in FIG. 9, as shown in FIG. 12, the shapes of intracellular tissues observed in the transmission microscopic image coincided with the shapes of the portions at each of which the green fluorescence was emitted.

In addition, the shape of the portion at which the fluorescence in the chlorella dyed with BODIPY (registered trade name), which has been known as a lipid labeling agent, was observed was similar to the shape of the portion at which the yellow autofluorescence in the chlorella without fluorescent dyeing show; in FIG. 8 was observed. From the results described above, it was confirmed that when the bandpass filter (BP 460-495) and the absorption filter (BA520IF) were used, the lipids in the chlorella emitted yellow autofluorescence.

### Reference Example 3

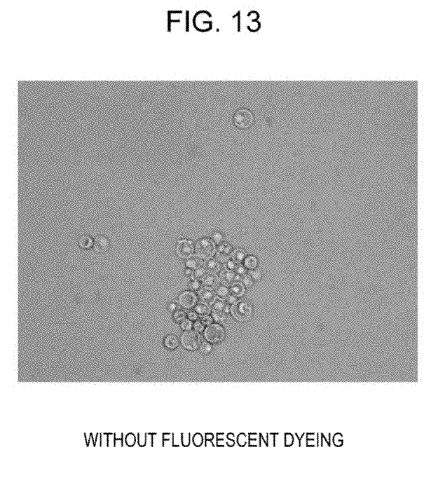

After 10 μL of a liquid C medium in which the chlorella without fluorescent dyeing was cultivated in the same manner as that in Reference Example 1 was dripped on a slide glass, a cover glass was placed thereon. Next, by a microscope equipped with an UIS manufactured by Olympus Corporation, a transmission microscopic image shown in FIG. 13 of the chlorella without fluorescent dyeing was taken.

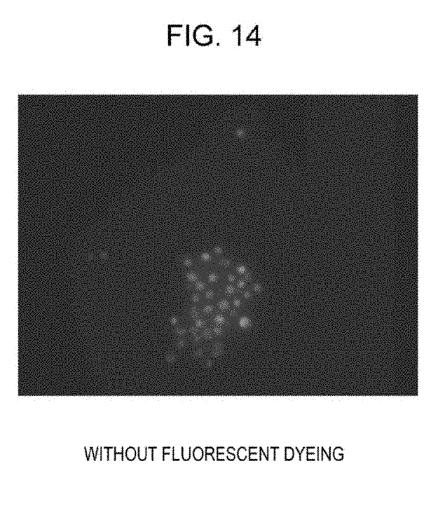

Subsequently, while the slide glass was not moved, a fluorescent microscopic image shown in FIG. 14 of the chlorella without fluorescent dyeing was taken by the same microscope. The imaging conditions were the same as those of Reference Example 1 shown in FIG. 6.

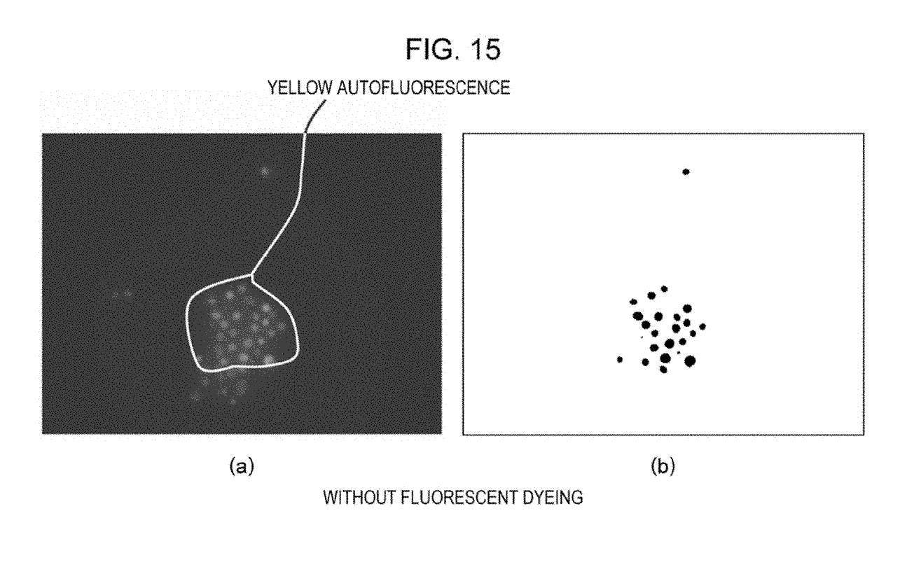

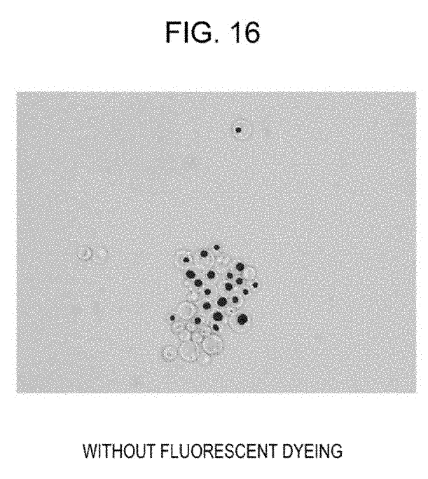

In the fluorescent microscopic image of the chlorella shown in FIG. 15(a), in a region surrounded by a line, yellow autofluorescence was mainly observed. In the other region, red autofluorescence was mainly observed. As shown in FIG. 15(b), by the use of an image analysis software (ImagePro), portions at each of which the yellow autofluorescence was emitted in the fluorescent microscopic image of the chlorella were extracted by black, and the other portion was shown by white, so that an extraction image of the autofluorescence was formed, when the extraction image of the portions at each of which the yellow autofluorescence was emitted shown in FIG. 15(b) was overlapped on the transmission microscopic image shown in FIG. 13, as shown in FIG. 16, the shapes of intracellular tissues observed in the transmission microscopic image coincided with the shapes of the portions at each of which the yellow autofluorescence was emitted.

### Reference Example 4

Nile Red which was a lipid labeling fluorescent dye having a peak wavelength of 637 nm was prepared and was then diluted in acetone, so that a fluorescent reagent solution having a concentration of 1 mg/mL was prepared. Next, to 200 μL of a liquid C medium containing the chlorella cultivated by the same method as that in Reference Example 3, 1.0 μL of the fluorescent reagent solution was added, so that the chlorella was dyed with Nile Red.

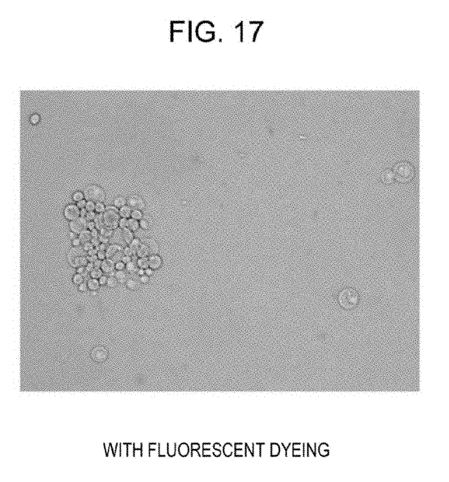

On the same day in which the microscopic observation of Reference Example 3 was performed, 10 μL of the liquid C medium containing the chlorella dyed with Nile Red was dripped on a slide glass, and a cover glass was placed thereon. Next, by a microscope equipped with an UIS manufactured by Olympus Corporation, a transmission microscopic image shown in FIG. 17 of the chlorella dyed with Nile Red was taken.

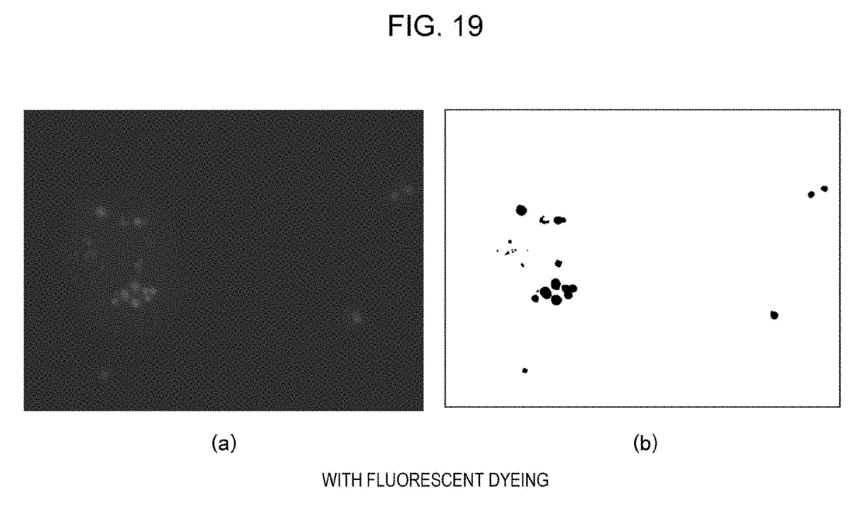

Subsequently, while the slide glass was not moved, a fluorescent microscopic image shown in FIG. 19 of the chlorella dyed with Nile Red was taken by the same microscope. In particular, wideband (WIG) excitation light was emitted through a bandpass filter (BP 530-550) to have a wavelength band of 530 to 550 nm and was Chen irradiated on the chlorella dyed with Nile Red through an object lens. The fluorescent generated in the chlorella which was dyed with Nile Red and which was irradiated with the excitation light was taken using a camera through an object lens and an absorption filter (BA575IF) which absorbed light having a wavelength of less than 575 nm and which allowed light having a wavelength of 575 nm or more to pass therethrough. An irradiation time of the excitation light (exposure time of the chlorella) was 1.0 second. In addition, for the excitation light, an ND filter having an average transmission rate (Tav) of 25% and an ND filter having an average transmission rate (Tav) of 6% were used.

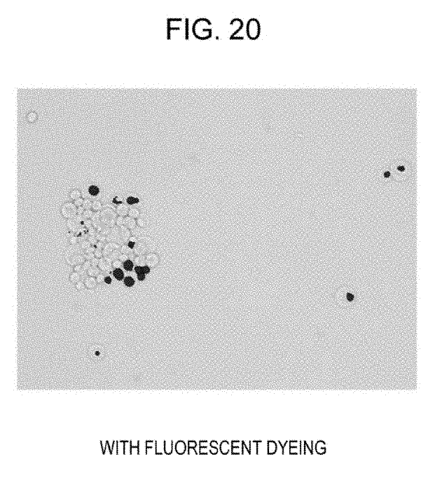

In the fluorescent microscopic image of the chlorella shown in FIG. 19(a), red fluorescence was mainly observed. As shown in FIG. 19(b), by the use of an image analysis software (imagePro), portions at each of which the red fluorescence was emitted in the fluorescent microscopic image of the chlorella were extracted by black, and the other portion was shown by white, so that an extraction image of the red fluorescence was formed. When the extraction image of the portions at each of which the red fluorescence was emitted shown in FIG. 19(b) was overlapped on the transmission microscopic image shown in FIG. 17, as shown in FIG. 20, the shapes of intracellular tissues observed in the transmission microscopic image coincided with the shapes of the portions at each of which the red fluorescence was emitted.

In addition, the shape of the portion at which the fluorescence in the chlorella dyed with Nile Red, which has been known as a lipid labeling agent, was observed was similar to the shape of the portion at which when the bandpass filter (BP 460-495) and the absorption filter (BA510IF) were used, the yellow autofluorescence in the chlorella without fluorescent dyeing shown in FIG. 16 was observed.

### REFERENCE SIGNS LIST

10 excitation light source
11 light source drive power source
12 power source control device
20A first light receiving element
20B second light receiving element
21A, 21B, 51 amplifier
22A, 22B, 52 amplifier power source
23A, 23B, 53 light intensity calculation device
24A, 24B, 54 light intensity storage device
40 flow cell
50 scattered light receiving element
102A first fluorescent light detector
102B second fluorescent light detector
105 scattered light detector
300 central processing unit
301 comparison unit
302 evaluation unit
303 size calculation unit.
401 output device

1. A detection device for lipids included in microalgae, comprising:
a flow cell through which a fluid containing microalgae flows;
an excitation light source irradiating excitation light on the flow cell; and
a first fluorescent light detector detecting auto fluorescence occurring in lipids of microalgae irradiated with the excitation light.

2. The detection device for lipids included in microalgae according to claim 1, wherein the autofluorescence occurring in the lipids is yellow.

3. The detection device for lipids included in microalgae according to claim 1, further comprising:
a scattered light detector detecting scattered light generated in the microalgae irradiated with the excitation light; and
a comparison unit comparing the intensity of the scattered light and the intensity of the autofluorescence occurring in the lipids.

4. The detection device for lipids included in microalgae according to claim 1, further comprising:
a fluorescent light detector detecting autofluorescence occurring in chloroplasts of the microalgae irradiated with the excitation light; and
a comparison unit comparing the intensity of the autofluorescence occurring in the chloroplasts and the intensity of the autofluorescence occurring in the lipids.

5. The detection device for lipids included in microalgae according to claim 1, further comprising:
a scattered light detector detecting scattered light generated in the microalgae irradiated with the excitation light;
a second fluorescent light detector detecting autofluorescence occurring in chloroplasts of the microalgae irradiated with the excitation light; and
a comparison unit comparing the intensity of the scattered light, the intensity of the autofluorescence occurring in the lipids, and the intensity of the autofluorescence occurring in the chloroplasts.

6. The detection device for lipids included in microalgae according to claim 1, further comprising: a size calculation unit calculating the size of the lipids based on the intensity of the autofluorescence occurring in the lipids.

7. The detection device for lipids included in microalgae according to claim 3, further comprising: a size calculation unit calculating the size of the microalgae based on the intensity of the scattered light generated in the microalgae.

8. The detection device for lipids included in microalgae according to claim 4, further comprising: a size calculation unit calculating the size of the chloroplasts based on the intensity of the autofluorescence occurring in the chloroplasts.

9. The detection device for lipids included in microalgae according to claim 1, wherein the microalgae are unicellular organisms.

10. The detection device for lipids included in microalgae according to claim 1, wherein the microalgae produce hydrocarbons.

11. A detection method for lipids included in microalgae, comprising:
allowing a fluid containing microalgae to flow through a flow cell;
irradiating excitation light on the flow cell; and
detecting autofluorescence occurring in lipids of microalgae irradiated with the excitation light.
